(19) United States
(12) Patent Application Publication
(10) Pub. No.: US 2025/0208828 A1
(43) Pub. Date: Jun. 26, 2025

(54) METHOD OF AUDIO PLAYBACK, AND APPARATUS THEREFOR

(71) Applicant: Harman International Industries, Incorporated, Stamford, CT (US)

(72) Inventor: Manuel Dominic CABALLERO, Romsey (GB)

(73) Assignee: Harman International Industries, Incorporated, Stamford, CT (US)

(21) Appl. No.: 18/990,182

(22) Filed: Dec. 20, 2024

(30) Foreign Application Priority Data
Dec. 21, 2023 (EP) 23219459.7

(51) Int. Cl. G06F 3/16

(52) U.S. Cl. CPC G06F 3/165

(57) ABSTRACT

The present disclosure relates to a method of audio playback, and in particular to a method of mitigating audible artifacts in audio playback from analog audio medium. The method includes the receipt of an analog audio signal including audio data from an analog audio medium; obtaining a digital reference signal associated with the analog audio medium; the output of said analog audio signal; and the intermittent switching from outputting said analog audio signal to outputting said digital reference signal based on a signal quality of said analog audio signal. Further provided is an apparatus for carrying out said method.

### CROSS-REFERENCE TO RELATED APPLICATIONS

This application which claims priority to and the benefit of European Patent Application No. 23219459.7, filed Dec. 21, 2023. The disclosure of the above application is incorporated herein by reference.

### FIELD

The present disclosure relates to a method of audio playback and apparatus therefor, and in particular to a method of mitigating audible artifacts in audio playback from analog audio medium, and an associated apparatus.

### BACKGROUND

The statements in this section merely provide background information related to the present disclosure and may not constitute prior art.

When looking to play audio from analog audio mediums, it may be desired to play back audio directly from the analog audio medium, such as a vinyl record, to maintain the audio characteristics and quality associated with said analog audio mediums. However, analog audio mediums are susceptible to physical damage, which may affect the quality of audio playback. For example, vinyl records may be scratched, which can in turn cause audible artifacts in the playback, affecting the audio played from the vinyl record from sounding as intended. In cases where the record cannot be replaced, the audio from the record can no longer be reproduced, and the intended audio can no longer be recovered.

While digital audio files may be reproduced, the characteristics and audio quality of digital signals may differ from the analog playback, and so may not be desired. There is therefore a need to allow for a high audio fidelity, while maintaining the analog characteristics of the audio.

### SUMMARY

This section provides a general summary of the disclosure and is not a comprehensive disclosure of its full scope or all of its features.

The present disclosure provides a method of audio playback, the method comprising: receiving an analog audio signal including audio data from an analog audio medium; obtaining a digital reference signal associated with the analog audio medium; outputting said analog audio signal; and intermittently switching from outputting said analog audio signal to outputting said digital reference signal based on a signal quality of said analog audio signal.

The method may be referred to as ‘restored replay mode’ that includes outputting audio from an analog audio medium, e.g., a record, and temporarily switching to a pre-recorded digital version of the audio when the quality of the audio from the analog audio source is below a certain threshold. This may be the case if the analog audio source (record) is damaged. Accordingly, the method allows audible artifacts to be mitigated when playing back analog audio.

In one or more embodiments, the method further comprises: playing the analog audio medium to generate a first analog signal and processing the first analog signal to obtain said digital reference signal; or playing an equivalent analog audio medium to generate a first analog signal and processing the first analog signal to obtain said digital reference signal. In the one or more embodiments, a digital reference signal can be obtained from the analog medium before physical damage occurs, such that the playback can be switched to the digital reference signal based on the quality of the analog audio signal, and the outputted audio signal can be equivalent to that of the undamaged analog medium. Accordingly, the one or more embodiments may represent a ‘reference playback mode’ in which the analog audio medium, or an equivalent analog medium to the analog medium intended to be played back, is played to provide an analog input signal (the “first analog signal”) to a digital signal processor, DSP, which generates the digital reference signal. In one or more examples, this is done when the analog audio medium is still new or undamaged.

In one or more embodiments, the method further comprises: playing the analog audio medium to generate a second analog signal; processing the second analog signal to obtain a digital audio signal; comparing the digital audio signal with said digital reference signal; and determining the signal quality of said analog audio signal based on the comparison. In the one or more embodiments, the signal quality of the analog audio signal can be compared to the digital reference signal, and audible artifacts in the analog audio signal can be ascertained. The one or more embodiments may represent a ‘recovery mode’ in which the analog audio medium is played and the resulting analog output signal (the “second analog signal”) is digitized and compared with the digital reference signal.

In one or more embodiments, the method further comprises: generating, based on the comparison, time data indicating at which time the signal quality of the digital signal associated with the second analog signal is below a predetermined threshold; wherein the time data comprises one or more timecodes indicating at which time the digital signal associated with the second analog signal deviates from the digital reference signal by more than a predetermined threshold and the duration of said deviations and said durations. In the one or more embodiments, the analog signal can be compared to the digital reference signal to generate up-to-date time data of any audible artifacts or periods of insufficient audio quality, such that audible artifacts can be mitigated during playback.

In the one or more embodiments, the method further comprises: switching from outputting said analog audio signal to outputting said digital reference signal when the digital audio signal deviates from said digital reference signal by more than a predetermined threshold. In the one or more embodiments, the playback can switch to a digital reference signal during audible artifacts, while an analog playback can be maintained throughout the rest of the playback.

In one or more embodiments, the method further comprises: obtaining time data associated with the digital reference signal; and intermittently switching from outputting said analog audio signal to outputting said digital reference signal based on the associated time data, wherein the time data indicates at which time the signal quality is below a predetermined threshold. In the one or more embodiments, time data indicating audible artifacts, or periods at which the analog signal quality is insufficient, can be obtained.

In the one or more embodiments, the time data comprises one or more timecodes indicating at which time a digital audio signal associated with the analog audio medium deviates from said digital reference signal by more than a predetermined threshold and the duration of said deviations, the method further comprising: storing the timecodes and durations as the time data. In the one or more embodiments, switching from outputting said analog audio signal to outputting said digital reference signal comprises: at each of the one or more timecodes, switching a playback patch such that an emission of the analog audio signal ceases and an emission of the associated digital reference signal begins; emitting the associated digital reference signal for the duration associated with the respective timecode; switching the playback patch upon the end of the duration associated with the respective timecodes such that emission of the associated digital reference signal ceases and emission of the analog audio signal continues. In the one or more embodiments, the need for manual switching between audio signals can be avoided.

In one or more embodiments, the method comprises: playing an analog audio medium; determining that there is a stored digital reference signal associated with the played analog audio medium; determining that there is stored time data associated with the played analog audio medium; and retrieving the stored digital reference signal and time data associated with the re-played analog audio medium. In the one or more embodiments, if it is determined that a digital reference signal and time data associated with the played analog audio medium is available, the digital reference signal and the time are retrieved. Where it is determined a digital reference signal and associated time data is stored, the need to create or download such data can be avoided, and the improved playback can begin.

In the one or more embodiments, determining that there is a stored digital reference signal associated with the played analog audio medium comprises: digitizing an analog signal corresponding to the re-played analog audio medium; performing audio recognition on the digitized analog audio signal; and identifying the associated digital reference signal based on the audio recognition. In such embodiments, the analog audio medium can be analyzed to determine the existence of a stored digital reference signal.

In one or more embodiments, said analog audio medium is a vinyl record. In the one or more embodiments, the vinyl record can be played back with an analog playback for as long as possible, while audible artifacts, such as those caused by damage to the vinyl record, can be mitigated.

The present disclosure further provides apparatus for use in audio playback, wherein the apparatus is configured to carry out the method of any of the preceding one or more embodiments.

In one or more embodiments, the apparatus further comprises: an analog to digital converter, ADC for generating said digital reference signal; a processor for generating said time data; a memory unit for storing said digital reference signal and said time data; and a controller for intermittently switching between an analog audio playback to a digital audio playback. In the one or more embodiments, audible artifacts can be mitigated, and the audio playback quality can be improved.

In one or more embodiments, the apparatus is configured to receive an audio signal from a vinyl record player. In the one or more embodiments, the vinyl record can be played back with an analog playback for as long as possible, while audible artifacts, such as those caused by damage to the vinyl record, can be mitigated.

In one or more embodiments, the apparatus is integrated in a vinyl record player. The complexity of use can therefore be reduced, and compatibility between the vinyl record player and the apparatus can be provided.

In one or more embodiments, the apparatus is further configured to switch from outputting the analog audio signal to outputting the digital reference signal when the digital audio signal deviates from the digital reference signal by more than a predetermined threshold.

In one or more embodiments, the apparatus is further configured to obtain time data associated with the digital reference signal and intermittently switch from outputting the analog audio signal to outputting the digital reference signal based on the associated time data, wherein the time data indicates at which time the signal quality is below a predetermined threshold. In the one or more embodiments, the time data comprises one or more timecodes indicating at which time the digital audio signal deviates from the digital reference signal by more than a predetermined threshold and a duration of the deviations and the apparatus is further configured to store the timecodes and durations as the time data.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates one or more embodiments of the disclosure in restored playback mode according to the principles of the present disclosure;

FIG. 2 illustrates one or more embodiments of the disclosure in reference playback mode;

FIG. 3 illustrates one or more embodiments of the disclosure in recovery mode;

FIG. 4 illustrates a method of the disclosure in restored playback mode;

FIG. 5 illustrates a method of the disclosure in reference playback mode;

FIG. 6 illustrates a method of the disclosure in recovery mode; and

FIG. 7 illustrates a method of the disclosure in restored playback mode.

One or more embodiments illustrated in the figures are intended to improve clarity, and are intended to be exemplary.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

While various aspects of the present disclosure are described with reference to a vinyl record as an analog audio medium, the skilled person will understand that any analog audio medium can be equivalently substituted unless otherwise explicitly stated, and the present disclosure is not limited to such embodiments. The present disclosure is not intended to be limited to such embodiments, and additional modifications, applications, and embodiments may be implemented without departing from the present disclosure. In the figures, like reference numerals have been used to illustrate the same or corresponding components. Those skilled in the art can recognize that the various components described may be altered without departing from the scope of the present disclosure.

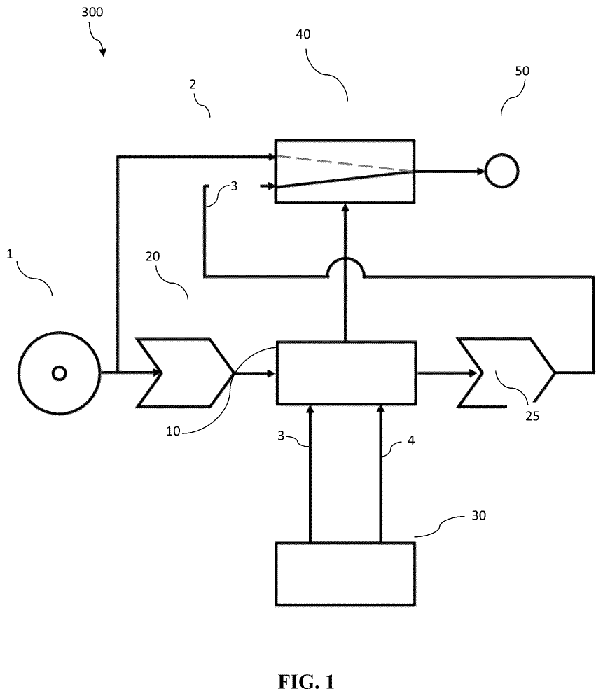

The detailed description is directed to a method and apparatus for mitigating audible artifacts in analog playback. FIG. 1 illustrates one or more embodiments of the disclosure ‘restored playback mode’. The one or more embodiments of FIG. 1 comprises an analog audio medium 1, an analog-to-digital converter (ADC) 20, a digital signal processor (DSP) 10, a memory unit 30, a digital-to-analog converter (DAC) 25, and a playback patch 40, also referred to as an analog switch. It can be understood that while the present disclosure refers to an ADC or a DAC, other components capable of converting analog or digital signals may be used. It can also be understood that while the present disclosure refers to the memory unit 30 being a flash memory, other means for storing a digital reference signal 3 or time data 4 may be used.

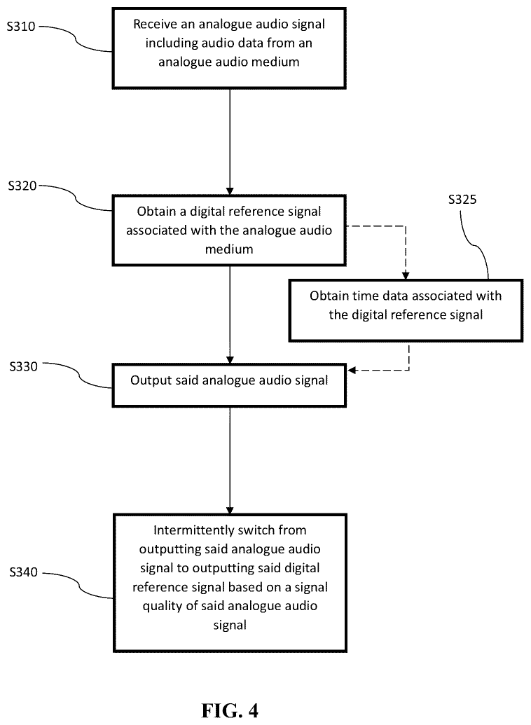

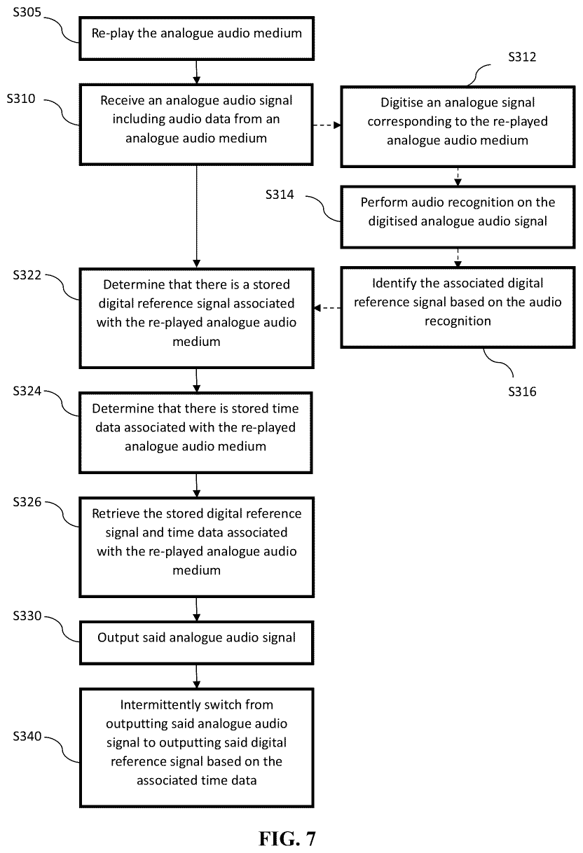

FIGS. 4 and 7 illustrate one or more embodiments of methods of the ‘restored playback mode’. In ‘restored playback mode’, the DSP 10 receives an audio signal from the analog audio medium 1 via the ADC 20, which digitizes the analog audio signal. In the one or more embodiments, the analog audio medium is a vinyl record. In one or more embodiments, alternative analog audio mediums may be used. In the one or more embodiments shown in FIG. 7, the DSP 10 then performs audio recognition on the digitized analog audio signal. Based on the results of the audio recognition, the DSP 10 can identify the associated digital reference signal 3. In one or more embodiments, the digital reference signal 3 can be manually identified by an operator.

The DSP 10 obtains the associated digital reference signal 3 representative of the audio signal. In the one or more embodiments of FIGS. 1 and 7, the digital reference signal 3 is stored locally in a flash memory 30, the DSP 10 determines that the digital reference signal 3 is stored, and the DSP 10 retrieves the digital reference signal 3 from the flash memory 30. In one or more embodiments, the digital reference signal 3 may be stored in a cloud, and the DSP 10 may retrieve the digital reference signal 3 from the cloud.

In the one or more embodiments of FIGS. 1, 4, and 7, the DSP 10 may obtain time data associated with the analog audio medium. This is an optional step of the method shown in FIG. 4. In the one or more embodiments shown in FIGS. 1 and 7, the DSP 10 further determines that there is stored time data associated with the analog audio medium, and retrieves the time data associated with the re-played analog audio medium. The time data of the one or more embodiments comprises timecodes at which the signal quality is below the predetermined threshold, and the duration for which it is below the threshold. In one or more embodiments, the signal quality, and thus the time data is based on the digitized analog audio signal deviating from the digital reference signal 3 by more than a predetermined threshold. In the one or more embodiments illustrated in FIGS. 1 and 7, the time data is stored locally on flash memory 30, and the DSP 10 retrieves the time data from the flash memory 30. However, in one or more embodiments, the time data may be stored on a cloud, and the DSP 10 may retrieve the time data from the cloud.

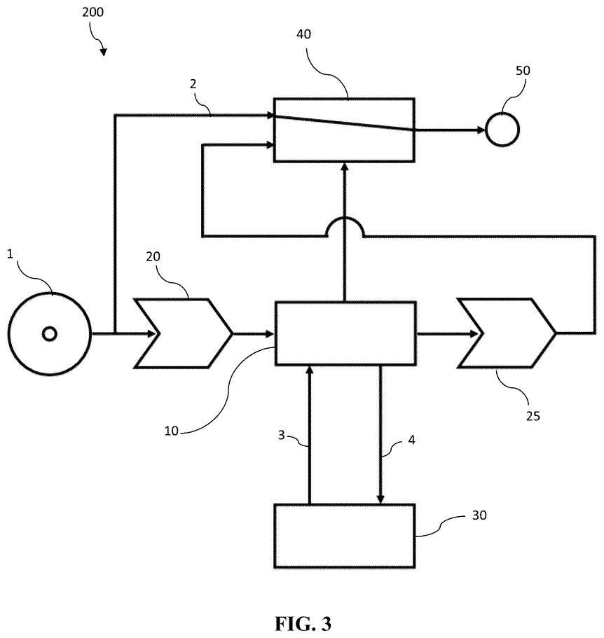

In the one or more embodiments shown in FIGS. 1, 4 and 7, the analog audio signal is output via the playback patch 40. The DSP 10 switches the playback patch 40 from outputting the analog audio signal to outputting said digital reference signal 3 based on a signal quality of said analog audio signal. In the one or more embodiments of FIGS. 1 and 7, the DSP obtains time data associated with the analog audio signal that indicates at which time the signal quality is below a predetermined threshold by retrieving it from the memory unit 30. As discussed in more detail with reference to FIG. 3, the predetermined threshold may be based on a deviation of the analog signal from the digital reference signal.

In the one or more embodiments illustrated in FIG. 1, the playback patch 40 is illustrated as a switch, wherein when the analog audio signal quality is at an acceptable quality, the playback patch 40 is connected to the analog audio signal, while when the signal quality is below a predetermined threshold, the playback patch 40 is connected to the DSP 10 via a DAC 25, and receives the digital reference signal 3 from the DSP 10.

When the time data indicates that the analog audio signal quality has returned to an acceptable quality, the DSP 10 switches the playback patch 40 from outputting the digital reference signal 3 to outputting the analog audio signal. In one or more embodiments, once a deviation has been detected, or once a time code has been determined, control elements such as a dead-band of values around the threshold, minimum durations recorded for the deviations, or a minimum intervals between deviations may be used to inhibit oscillations in the audio signal outputted from output 50 of the playback patch 40. In the one or more embodiments, during section of audio that is affected by damage, even if which the digitized analog audio signal oscillates and therefore includes brief peaks above the threshold, it may be still recorded as a single deviation. In the one or more embodiments, the quality of audio played back in the ‘restored playback mode’ may be improved, the resources desired in ‘restored playback mode’ may be reduced, and the storage requirements for storing the time data can be reduced.

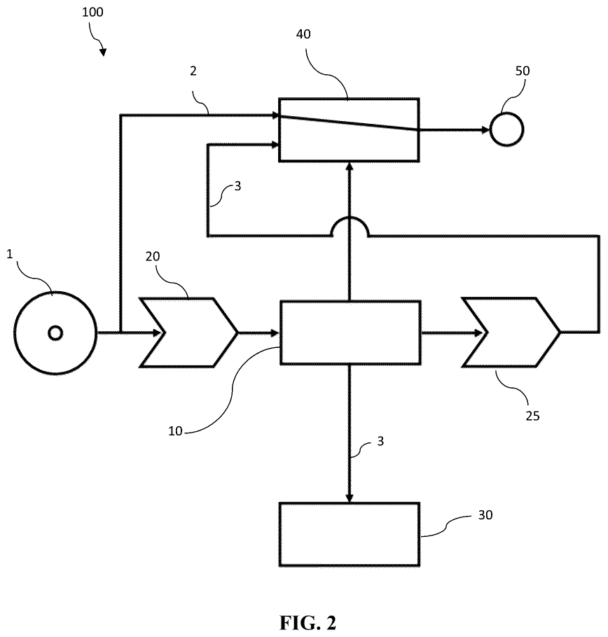

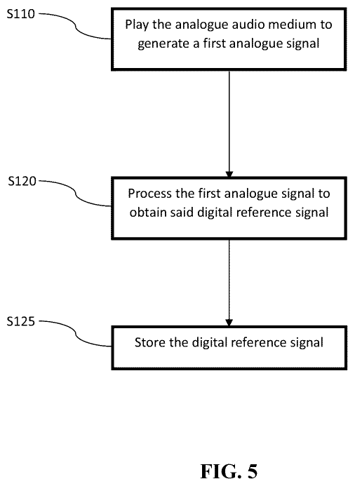

Illustrated in FIG. 2 is one or more embodiments of the present disclosure in ‘reference playback mode’. FIG. 5 illustrates one or more embodiments of a method of the ‘reference playback mode’. The operator may play the vinyl record 1 to generate a first analog signal, such that the DSP 10 can process the first analog signal to obtain the digital reference signal 3. In one or more examples, the analog audio medium 1 is undamaged or minimally damage, such as may be the case shortly after the analog audio medium has been produced or acquired. In the one or more embodiments, the digital reference signal 3 generated is representative of the originally intended analog audio, without audible artifacts or having reduced audible artifacts. In the one or more embodiments of FIG. 2, the DSP 10 can further store the digital reference signal 3 in a local flash memory 30. In one or more embodiments, the digital reference signal may be stored on a cloud. In one or more embodiments, the digital reference signal 3 may be generated from a different analog audio medium than the analog audio medium used for the ‘restored playback mode’ or the ‘recovery mode’. In the one or more embodiments, the digital reference signal 3 may have been provided by the producer of the analog audio medium 1, or may have been generated by an equivalent analog audio medium. In cases where it has not been possible to generate a digital reference signal using the analog audio medium before it has been damaged, it may be desired to obtain a digital reference signal generated from an equivalent analog audio medium to best mitigate the audible artifacts.

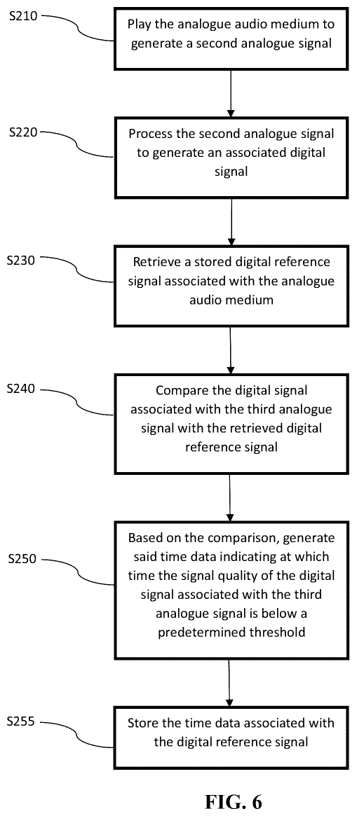

FIG. 3 illustrates one or more embodiments of the present disclosure in ‘recovery mode’. FIG. 6 illustrates one or more embodiments of a method of the ‘recovery mode’. In recovery mode, the DSP 10 may receive a second analog signal from the analog audio medium. In the one or more embodiments, the analog audio medium is the same analog audio medium used to generate the digital reference signal. In the one or more embodiments, ‘recovery mode’ may be temporally separated from ‘reference playback mode’, or may be used after damage to the analog audio medium is detected or suspected. The operator may carry out a method of ‘recovery mode’, whenever a change in the physical state of the analog audio medium that may cause the analog audio signal to change is detected or suspected, such that audible artifacts can be mitigated, and the quality of the audio playback can be improved. However, in one or more embodiments, the digital reference signal 3 may be generated using a different analog audio medium, such as an analog audio medium intended to produce an equivalent analog audio signal. In the one or more embodiments, the ADC 20 processes the second analog signal to obtain a digital audio signal. In one or more embodiments, other components may be used to obtain the digital audio signal. The DSP 10 uses the digital audio signal to obtain the digital reference signal. In one or more embodiments, the DSP 10 performs audio recognition on the digital audio signal, identifies the associated digital reference signal 3 and retrieves the associated digital reference signal 3. In one or more embodiments, the associated digital reference signal 3 may be identified in other ways, such as being manually identified by the operator. The DSP 10 compares the digital audio signal with the associated digital reference signal, and determines the signal quality of said analog audio signal based on the comparison.

In the one or more embodiments illustrated in FIGS. 3 and 6, the DSP 10 determines one or more time codes at which the digital audio signal deviates from the associated digital reference signal 3 by greater than a predetermined threshold. The DSP 10 further determines the duration for which the digital audio signal deviates from the associated digital reference signal 3 at each of the one or more time codes. In one or more embodiments, the predetermined threshold is a single threshold employed throughout duration of the digital reference signal 3. In one or more embodiments, the predetermined threshold may vary throughout the duration of the digital reference signal 3. The DSP 10 then generates the time data indicating at which time the signal quality of the digital signal associated with the second analog signal is below a predetermined threshold, and in particular generating said timecodes indicating at which time the digital signal associated with the second analog signal deviates from the retrieved digital reference signal by more than a predetermined threshold and the duration of said deviations. In the method shown in FIGS. 3 and 6, the generated time data may then be stored in the memory unit 30. Once the time data has been generated, the operator may use the time data in ‘restored playback mode’ as shown in FIG. 4 or FIG. 7 and discussed above.

In a second aspect, the present disclosure provides an apparatus for audio playback. The apparatus may include the analog to digital converter (ADC) 20 for generating said digital reference signal 3; a processor for generating said time data; a memory unit 30 for storing said digital reference signal 3 and said time data; and a controller for intermittently switching between an analog audio playback to a digital audio playback. In the one or more embodiments of FIGS. 1-3, the memory unit 30 is flash memory, however other types of memory may be used. In the one or more embodiments of FIGS. 1-3, DSP 10 comprises the processor and the controller. In the one or more embodiments, the processor and the controller are integrated. However, in one or more embodiments, the components may not be integrated. In one or more embodiments, the ADC 20 may be an ADC/DAC combined unit.

In one or more embodiments, the apparatus is configured to receive an audio signal from a vinyl record player. In some embodiments, the apparatus may be connectable to a vinyl record player, such as a pre-existing vinyl record player. In one or more embodiments, the apparatus is integrated in a vinyl record player.

According to one or more embodiments of the present disclosure, it is also envisaged that that the manufacturer of the vinyl record provides a digital copy of the audio signal of the vinyl record, i.e., the digital reference signal, for the purposes mitigating any audible artifacts when playing back the vinyl record. The digital copy could be provided for download by a customer. In particular, the digital copy could be made available for download by providing a QR code on the sleeve of the vinyl record, which the customer can scan to activate the download.

Accordingly, a method in accordance with one or more embodiments of the present disclosure may include any of the following steps:

A customer purchases a vinyl record.

The customer scans a QR code on the sleeve of the vinyl record.

This causes a digital copy (also “digital master”) of the record to be downloaded to the record player/turntable. The digital copy may be based on the master recording used to press the record.

During an ‘analysis’ playback, the apparatus compares the record to the downloaded digital master and determines timestamps when defects are identified

During subsequent ‘normal’ playback, the turntable substitutes digital segments to mask the damaged record playback. As it has the timestamps from the analysis and a full digital copy of the master recording, it can do this with no user intervention.

As a record becomes increasingly damaged over time, the user can repeat the ‘analysis’ playback to update the corrected segments.

As the turntable knows how many substitutions it is making, it can advise the user how damaged/worn the record is.

This additional service can be a revenue source for the record company as well as the equipment (record player) manufacturer.

One or more embodiment of the present disclosure relates to a concept of an analysis of a playback, wherein a player plays a record, makes a digital conversion as it is playing the record and compares it to an internally stored digital version of the record. An embedded DSP identifies any discrepancies (e.g., due to damage to the record) and makes a note of the timestamp (position) of the defect. No correction takes place during the analysis playback so the user would still hear the defects.

During subsequent playbacks, the DSP tracks the playback and when a defect timestamp is reached (or just before), it switches the native analog playback to the segment of digital recording stored in an internal memory. The duration of the substitution typically is short (e.g., a few milliseconds) but it corresponds to the length of time determined to be defective during the analysis playback. After the substitution is complete, the player switches back to native analog playback of the record.

By substituting the segments thus, the user can enjoy near-perfect vinyl record playback even when there is light to moderate damage to the record. The playback is still a “pure analog” playback except for short corrected segments. Thus, a system according to one or more embodiments of the present disclosure still provides a true vinyl record playback experience, not a digitized version of it.

The user can repeat the analysis playback to update the discrepancy list if the record sustains new damage.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of audio playback, the method comprising:
receiving an analog audio signal including audio data from an analog audio medium;
obtaining a digital reference signal associated with the analog audio medium;
outputting the analog audio signal; and
intermittently switching from outputting the analog audio signal to outputting the digital reference signal based on a signal quality of the analog audio signal.

2. The method of claim 1, further comprising:
playing the analog audio medium to generate a first analog signal; and
processing the first analog signal to obtain the digital reference signal.

3. The method of claim 1, further comprising:
playing the analog audio medium to generate a second analog signal;
processing the second analog signal to obtain a digital audio signal;
retrieving the digital reference signal associated with the analog audio medium;
comparing the digital audio signal with the digital reference signal; and
determining the signal quality of the analog audio signal based on comparing the digital audio signal with the digital reference signal.

4. The method of claim 3, further comprising:
generating, based on comparing the digital audio signal with the digital reference signal, time data indicating at which time the signal quality of the digital signal associated with the second analog signal is below a predetermined threshold; wherein the time data comprises one or more timecodes indicating at which time the digital signal associated with the second analog signal deviates from the digital reference signal by more than a predetermined threshold, a duration of the deviations, and a duration associated with the time.

5. The method of claim 1, further comprising:
switching from outputting the analog audio signal to outputting the digital reference signal when the digital audio signal deviates from the digital reference signal by more than a predetermined threshold.

6. The method of claim 1, further comprising:
obtaining time data associated with the digital reference signal; and
intermittently switching from outputting the analog audio signal to outputting the digital reference signal based on the associated time data, wherein the time data indicates at which time the signal quality is below a predetermined threshold.

7. The method of claim 6, wherein the time data comprises one or more timecodes indicating at which time the digital audio signal deviates from the digital reference signal by more than a predetermined threshold and a duration of the deviations, the method further comprising:
storing the timecodes and durations as the time data.

8. The method of claim 7, wherein switching from outputting the analog audio signal to outputting the digital reference signal comprises:
at each of the one or more timecodes, switching a playback patch such that an emission of the analog audio signal ceases and an emission of the associated digital reference signal begins;
emitting the digital reference signal for the duration associated with the respective timecode; and
switching the playback patch upon an end of the duration associated with the respective timecodes such that emission of the digital reference signal ceases and emission of the analog audio signal continues.

9. The method of claim 1, further comprising:
playing the analog audio medium;
determining that there is a stored digital reference signal associated with the played analog audio medium;
determining that there is stored time data associated with the played analog audio medium; and
retrieving the stored digital reference signal and time data associated with the played analog audio medium.

10. The method of claim 1, further comprising:
digitizing an analog signal corresponding to the analog audio medium;
performing audio recognition on the digitized analog audio signal; and
identifying the associated digital reference signal based on the audio recognition.

11. The method of claim 1, wherein the analog audio medium is a vinyl record.

12. An apparatus for use in audio playback, wherein the apparatus is configured to:
receive an analog audio signal including audio data from an analog audio medium;
obtain a digital reference signal associated with the analog audio medium;
output the analogue audio signal; and
intermittently switch from outputting the analog audio signal to outputting the digital reference signal based on a signal quality of the analog audio signal.

13. The apparatus of claim 12, further comprising:
an analog to digital converter (ADC) for generating the digital reference signal;
a processor for generating time data;
a memory unit for storing the digital reference signal and the time data; and
a controller for intermittently switching between an analog audio playback to a digital audio playback.

14. The apparatus of claim 12, wherein the apparatus is configured to receive an audio signal from a vinyl record player.

15. The apparatus of claim 14, wherein the apparatus is integrated in a vinyl record player.

16. The apparatus of claim 12, wherein the apparatus is further configured to:
switch from outputting the analog audio signal to outputting the digital reference signal when the digital audio signal deviates from the digital reference signal by more than a predetermined threshold.

17. The apparatus of claim 12, wherein the apparatus is further configured to:
obtain time data associated with the digital reference signal; and
intermittently switch from outputting the analog audio signal to outputting the digital reference signal based on the associated time data, wherein the time data indicates at which time the signal quality is below a predetermined threshold.

18. The apparatus of claim 17, wherein the time data comprises one or more timecodes indicating at which time the digital audio signal deviates from the digital reference signal by more than a predetermined threshold and a duration of the deviations, the apparatus further configured to:
storing the timecodes and durations as the time data.

19. The apparatus of claim 18, wherein switching from outputting the analog audio signal to outputting the digital reference signal comprises:
at each of the one or more timecodes, switching a playback patch such that an emission of the analog audio signal ceases and an emission of the associated digital reference signal begins;
emitting the digital reference signal for the duration associated with the respective timecode; and
switching the playback patch upon an end of the duration associated with the respective timecodes such that emission of the digital reference signal ceases and emission of the analog audio signal continues.

20. The method of claim 1, further comprising:
playing an equivalent analog audio medium to generate a first analog signal; and
processing the first analog signal to obtain said digital reference signal.
